(19) United States
(12) Patent Application Publication
(10) Pub. No.: US 2024/0090048 A1
(43) Pub. Date: Mar. 14, 2024

(54) COMMUNICATION APPARATUS AND COMMUNICATION SYSTEM

(71) Applicant: KYOCERA Corporation, Kyoto (JP)

(72) Inventors: Yuki URANO, Kawasaki-shi (JP); Noboru ABE, Tokyo (JP); Kenji KATO, Yokohama-shi (JP)

(73) Assignee: KYOCERA Corporation, Kyoto (JP)

(21) Appl. No.: 18/514,831

(22) Filed: Nov. 20, 2023

Related U.S. Application Data
(63) Continuation of application No. PCT/JP2022/020549, filed on May 17, 2022.

(30) Foreign Application Priority Data
May 25, 2021 (JP) 2021-087968

(51) Int. Cl. H04W 76/10

(52) U.S. Cl. CPC H04W 76/10; H04W 84/20

(57) ABSTRACT

A communication apparatus includes: a first communicator capable of wireless-communicating using a cellular communication scheme; a second communicator capable of wireless-communicating with another communication apparatus using a first communication scheme (not the cellular communication scheme); and a controller controlling the first and second communicators to execute a first communication mode. The second communicator transmits a wireless connection request to the other communication apparatus in the first communication mode. The first communication mode is a communication mode in which the communication apparatus is a slave device for another communication apparatus (access point), communication through the cellular communication scheme and communication through the first communication scheme are relayed, and a wireless service is provided, via the other communication apparatus, to a terminal apparatus capable of wireless-communicating with the other communication apparatus through the first communication scheme.

### RELATED APPLICATIONS

The present application is a continuation based on PCT Application No. PCT/JP2022/020549, filed on May 17, 2022, which claims the benefit of Japanese Patent Application No. 2021-087968 filed on May 25, 2021. The content of which is incorporated by reference herein in their entirety.

### TECHNICAL FIELD

The present disclosure relates to a communication apparatus and a communication system.

### BACKGROUND OF INVENTION

In recent years, a cellular communication system conforming to a fifth generation (5G) cellular communication standard has been attracting attention. In a 5G cellular communication system, various use cases are assumed, such as high speed and large capacity (enhanced Mobile Broadband (eMBB)), and multiple simultaneous connections (massive Machine Type Communication (mMTC)). Therefore, such a cellular communication system is expected to contribute not only to wireless communication using mobile phone but also to innovation of related technologies such as Artificial Intelligence (AI) and automated driving.

On the other hand, a wireless Local Area Network (LAN) system conforming to Institute of Electrical and Electronics Engineering (IEEE) 802.11ax (or Wi-Fi (registered trademark) 6. May hereinafter be referred to as “Wi-Fi 6”) has also been attracting attention. In the wireless LAN system conforming to Wi-Fi 6, Orthogonal Frequency-Division Multiple Access (OFDMA) has been newly introduced. Therefore, in such a wireless LAN system, throughput can be improved more than in conventional wireless LAN systems.

An access point is also available that can be wirelessly connected to a slave device (or a terminal) using a wireless LAN and can wirelessly communicate with a base station or the like using cellular communication. Such an access point can provide a wireless service acquired using cellular communication to a slave device using a wireless LAN.

### CITATION LIST

### Non-Patent Literature

Non-Patent Document 1: 3GPP TS38.300 V16.4.0 (2021-01) Non-Patent Document 2: Wi-Fi CERTIFIED 6TM: A new era in wireless connectivity, September 2019, Wi-Fi ALLIANCE

### SUMMARY

A communication apparatus according to a first aspect includes: a first communicator capable of wirelessly communicating using a cellular communication scheme; a second communicator capable of wirelessly communicating with another communication apparatus using a first communication scheme different from the cellular communication scheme; and a controller controlling the first and second communicators to execute a first communication mode. The second communicator transmits a wireless connection request to the other communication apparatus in the first communication mode. The first communication mode is a communication mode in which the communication apparatus is a slave device with respect to another communication apparatus being an access point, communication through the cellular communication scheme and communication through the first communication scheme are relayed, and a wireless service is provided, via the other communication apparatus, to a terminal apparatus capable of wirelessly communicating with the other communication apparatus through the first communication scheme.

A communication apparatus according to a second aspect includes: a communicator capable of wirelessly communicating with another communication apparatus and a terminal apparatus using a first communication scheme different from a cellular communication scheme; and a controller. The communicator receives a wireless connection request from the other communication apparatus in the first communication mode. The controller maintains a connection to the terminal apparatus even when the communicator receives the wireless connection request. The first communication mode is a communication mode in which the other communication apparatus is a slave device with respect to the communication apparatus being an access point, communication through the cellular communication scheme and communication through the first communication scheme are relayed by the other communication apparatus, and a wireless service is provided to the terminal apparatus.

A communication system according to a third aspect includes: a first communication apparatus capable of wirelessly communicating using a cellular communication scheme and capable of wirelessly communicating using a first communication scheme different from the cellular communication scheme; a second communication apparatus capable of wirelessly communicating with the first communication apparatus using the first communication scheme; and a terminal apparatus capable of wirelessly communicating with the second communication apparatus using the first communication scheme. The first communication apparatus transmits a wireless connection request to the second communication apparatus in the first communication mode. The second communication apparatus maintains a connection to the terminal apparatus even when receiving the wireless connection request. The first communication mode is a communication mode in which the first communication apparatus is a slave device with respect to the second communication apparatus being an access point, communication through the cellular communication scheme and communication through the first communication scheme are relayed by the first communication apparatus, and a wireless service is provided to the terminal apparatus via the second communication apparatus.

### BRIEF DESCRIPTION OF THE DRAWINGS

FIGS. 1A and 1B are diagrams illustrating a configuration of a communication system according to a first embodiment.

FIG. 2A is a diagram illustrating a configuration example of a first communication apparatus according to the first embodiment, and FIG. 2B is a diagram illustrating a configuration example of a second communication apparatus according to the first embodiment.

FIG. 3 is a diagram illustrating a configuration example of a slave device according to the first embodiment.

FIG. 4 is a flowchart illustrating an operation example of a Comparative Example according to the first embodiment.

FIG. 5 is a flowchart illustrating an operation example according to the first embodiment.

FIGS. 6A and 6B are diagrams illustrating configuration examples of a communication system according to a second embodiment.

FIG. 7 is a flowchart illustrating an operation example according to the second embodiment.

FIG. 8 is a diagram illustrating an example of a predetermined image displayed on a display according to the second embodiment.

FIGS. 9A to 9D are diagrams illustrating example icons according to the second embodiment.

### DESCRIPTION OF EMBODIMENTS

An aspect of the present disclosure aims to appropriately maintain a connection to a slave device (or a terminal).

Embodiments will be described with reference to the drawings. In the description of the drawings, the same or similar parts are denoted by the same or similar reference signs.

### First Embodiment

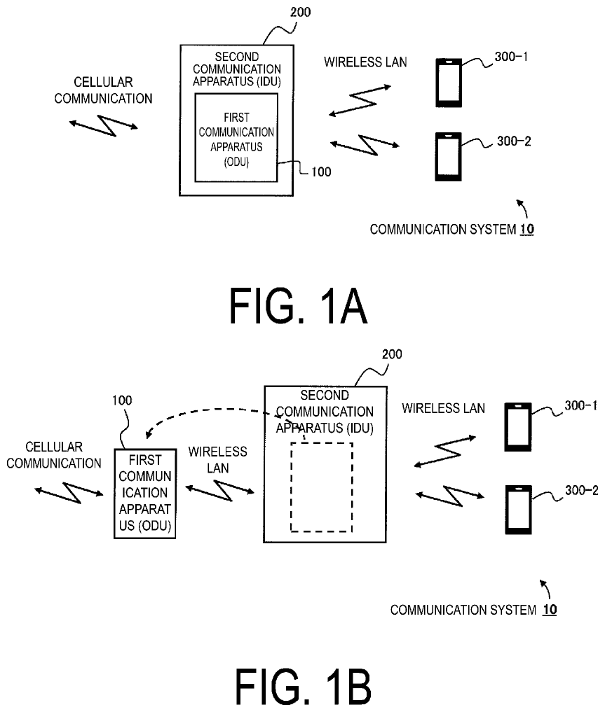

A first embodiment will be described first. FIGS. 1A and 1B are diagrams illustrating a configuration example of a communication system 10 according to the first embodiment.

As illustrated in FIG. 1A, the communication system 10 includes a first communication apparatus 100, a second communication apparatus 200, and terminal apparatuses (or slave devices. May hereinafter be referred to as “slave devices”) 300-1 and 300-2.

The communication system 10 is capable of being on standby for cellular communication, and of routing communication to the slave devices 300-1 and 300-2 through the second communication apparatus 200. If a wireless connection to the second communication apparatus 200 can be established through a wireless LAN, the slave devices 300-1 and 300-2 can gain access to cellular communication via the second communication apparatus 200. In the example of FIG. 1A, the second communication apparatus 200 functions as a router that routes (or relays. “Route” and “relay” may hereinafter be used without distinction) the cellular communication and the wireless LAN. In the example of FIG. 1A, the second communication apparatus 200 functions as an access point with respect to the slave devices 300-1 and 300-2.

The first communication apparatus 100 is detachable from the second communication apparatus 200. FIG. 1A illustrates an example in a state where the first communication apparatus 100 is attached to the second communication apparatus 200. On the other hand, FIG. 1B illustrates an example in a state where the first communication apparatus 100 is detached from the second communication apparatus 200.

As illustrated in FIG. 1B, when the first communication apparatus 100 is detached from the second communication apparatus 200, the communication system 10 enables establishing a wireless connection between the first communication apparatus 100 and the second communication apparatus 200. That is, the slave devices 300-1 and 300-2 can gain access to the cellular communication via the second communication apparatus 200 and the first communication apparatus 100, allowing the slave apparatuses 300-1 and 300-2 to receive the wireless service provided by the cellular communication.

For example, in FIG. 1B, a case is considered where the second communication apparatus 200 is installed indoors where a reception state for the cellular communication is poor. In this case, as shown in FIG. 1B, a user can remove the first communication apparatus 100 and place the first communication apparatus 100 near a window. As a result, in the communication system 10, the reception state for the cellular communication can be easily improved.

In FIG. 1B, the first communication apparatus 100 performs routing between the cellular communication and the wireless LAN. That is, the first communication apparatus 100 routes the cellular communication, and the wireless LAN to the second communication apparatus 200. The first communication apparatus 100 can wirelessly communicate with the second communication apparatus 200 using the wireless LAN.

As described with reference to FIGS. 1A and 1B, the first communication apparatus 100 is detachable from the second communication apparatus 200. The first communication apparatus 100 has a charging function. On the other hand, the second communication apparatus 200 has a power feeding function. When the first communication apparatus 100 is attached to the second communication apparatus 200, the first communication apparatus 100 can receive power from the second communication apparatus 200.

In FIG. 1B, the second communication apparatus 200 routes wireless LAN communication with the first communication apparatus 100, and wireless LAN communication with the slave devices 300-1 and 300-2. The second communication apparatus 200 is capable of performing wireless communication with the first communication apparatus 100 and the slave devices 300-1 and 300-2 using the wireless LAN.

In FIGS. 1A and 1B, the slave devices 300-1 and 300-2 are, for example, smartphones, tablet terminals, or laptop PCs. The slave devices 300-1 and 300-2 can communicate with the second communication apparatus 200 using the wireless LAN. The slave devices 300-1 and 300-2 can receive the wireless service provided by the cellular communication via the second communication apparatus 200.

Note that FIGS. 1A and 1B illustrate an example in which there are two slave devices 300-1 and 300-2, there may also be one slave device or three or more slave devices. Hereinafter, the slave devices 300-1 and 300-2 may be referred to as slave device(s) 300.

Hereinafter, the first communication apparatus 100 may be referred to as an Outdoor Unit (ODU) 100. The second communication apparatus 200 may be referred to as an Indoor Unit (IDU) 200.

In the following description, a wireless communication scheme conforming to 5G will be described as an example of the cellular communication. However, a wireless communication scheme conforming to a generation after 5G may be used.

In the following description, Wi-Fi 6 will be described as an example of the wireless LAN. However, in place of the wireless LAN, another Wi-Fi (registered trademark) other than Wi-Fi 6 and/or a short-range wireless communication scheme other than the wireless LAN may be utilized. Examples of the short-range wireless communication scheme include Bluetooth (registered trademark), Zigbee (registered trademark), and Bluetooth Low Energy (BLE). As described above, the wireless LAN scheme or the short-range wireless communication scheme is used as a first communication scheme different from the communication scheme of the cellular communication.

### Configuration Example of ODU

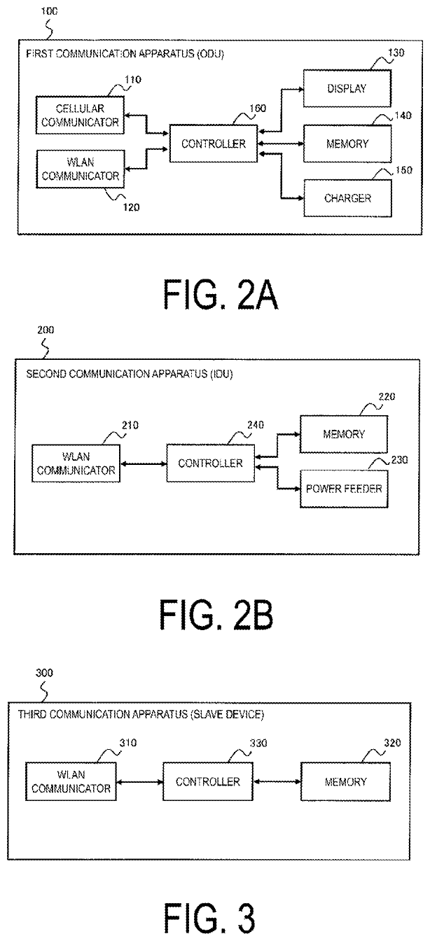

A configuration example of the ODU 100 will be described. FIG. 2A is a diagram illustrating the configuration example of the ODU 100.

As illustrated in FIG. 2A, the ODU 100 includes a cellular communicator 110, a Wireless Local Area Network (WLAN) communicator 120, a display 130, a memory 140, a charger 150, and a controller 160.

The cellular communicator 110 performs wireless communication with radio base stations and the like using a wireless communication scheme conforming to 5G. That is, the cellular communicator 110 converts (down-converts) a radio signal received from a radio base station or the like into a baseband signal in a base band, and outputs the baseband signal to the controller 160. Upon receiving a baseband signal from the controller 160, the cellular communicator 110 converts (up-converts) the received baseband signal into a radio signal, and transmits the radio signal to a radio base station or the like.

The WLAN communicator 120 performs wireless communication with the IDU 200 using a wireless communication scheme conforming to Wi-Fi 6. That is, the WLAN communicator 120 converts (down-converts) a radio signal received from the IDU 200 into a baseband signal, and outputs the baseband signal to the controller 160. Upon receiving a baseband signal from the controller 160, the WLAN communicator 120 converts (up-converts) the received baseband signal into a radio signal, and transmits the radio signal to the IDU 200. The WLAN 120 can transmit and receive various types of messages by transmitting and receiving radio signals to and from the IDU 200 in this way.

The display 130 displays a predetermined image under the control of the controller 160. Examples of the predetermined image include a first icon indicating a radio signal strength of communication between the IDU 200 and the slave device 300. Examples of the predetermined image also include a second icon indicating a radio signal strength of communication between the ODU 100 and the IDU 200. Examples of the first icon and the second icon will be described in an operation example. The display 130 can display various information or images other than the predetermined image under the control of the controller 160.

The memory 140 stores a program and data. The program is read from the memory 140 and executed by the controller 160, so that various functions are realized by the controller 160. The memory 140 is used as a work region that temporarily stores a processing result of the controller 160. The memory 140 may be a freely selected non-transitory storage medium such as a semiconductor storage medium.

The charger 150 charges with electricity fed from the IDU 200. Upon removing the ODU 100 from the IDU 200, the electricity fed to the charger 150 is supplied to the units 110, 120, 130, 140, and 160 of the ODU 100 under the control of the controller 160, making the units 110, 120, 130, 140, and 160 operable.

The controller 160 controls the unit 110 and the like of the ODU 100. The controller 160 can execute a “slave device tethering mode” by controlling the cellular communicator 110 and the WLAN communicator 120. For example, the controller 160 can execute the “slave device tethering mode” by performing the following control.

That is, the controller 160 controls the WLAN communicator 120 so that ODU 100 becomes a slave device with respect to IDU 200 serving as an access point. Specifically, the controller 160, for example, controls the WLAN communicator 120 so that the WLAN communicator 120 does not transmit a beacon message to the IDU 200, and can receive a beacon message transmitted from the IDU 200.

The controller 160 outputs the baseband signal output from the cellular communicator 110 to the WLAN communicator 120, and outputs the baseband signal output from the WLAN communicator 120 to the cellular communicator 110. As a result, the ODU 100 can relay the cellular communication and the wireless LAN, and serve as a tethering function.

When the controller 160 executes the “slave device tethering mode”, the WLAN communicator 120 transmits a Wi-Fi connection request message to the IDU 200 under the control of the controller 160. The Wi-Fi connection request message may be a wireless connection request or a 5G routing request made by the ODU 100 to the IDU 200. The IDU 200, having received the Wi-Fi connection request message, is allowed to continue functioning as an access point, for example.

### Configuration Example of IDU

A configuration example of the IDU 200 will be described. FIG. 2B is a diagram illustrating the configuration example of the IDU 200.

As illustrated in FIG. 2B, the IDU 200 includes a WLAN communicator 210, a memory 220, a power feeder 230, and a controller 240.

The WLAN communicator 210 can wirelessly communicate with the ODU 100 using a wireless communication scheme conforming to Wi-Fi 6. The WLAN communicator 210 can wirelessly communicate with the slave device 300 using the wireless communication scheme. That is, the WLAN communicator 210 converts (down-converts) a radio signal received from the ODU 100 or the slave device 300 into a baseband signal and, outputs the baseband signal to the controller 240. The WLAN communicator 210 converts (up-converts) a baseband signal received from the controller 240 into a radio signal, and transmits the radio signal to the ODU 100 or the slave device 300. Through such transmission and reception of radio signals, the IDU 200 can wirelessly communicate with the ODU 100 or the slave device 300 using Wi-Fi 6.

The memory 220 stores a program and data. The program is read from the memory 220 and executed by the controller 240, so that various functions are realized in the controller 240. The memory 220 is used as a work region that temporarily stores a processing result of the controller 240. The memory 220 may be a freely selected non-transitory storage medium such as a semiconductor storage medium.

When the ODU 100 is attached to the IDU 200, the power feeder 230 can feed power from a power source to the ODU 100. The power feeder 230 is electrically connected to the charger 150 of the ODU 100 and feeds power to the charger 150. The power feeder 230 may feed power to the charger 150 when detecting an electrical connection to the charger 150. The IDU 200 functions as a power feeding table for the ODU 100.

The controller 240 controls the units 210, 220, and 230 of the IDU 200. The controller 240 maintains the connection to the slave device 300 even when receiving a wireless connection request from the ODU 100 in the “slave device tethering mode” via the WLAN communicator 210.

That is, the controller 240 controls the WLAN communicator 210 so that the WLAN communicator 210 continues to function as an access point. Specifically, the controller 240, for example, controls the WLAN communicator 210 so that the WLAN communicator 210 transmits a beacon message. Since the ODU 100 in the “slave device tethering mode” does not transmit a beacon message, the WLAN communicator 210 continuously transmits a beacon message to continue functioning as an access point, for example. By receiving a wireless connection request from the ODU 100 in the “slave device tethering mode” via the WLAN communicator 210, the controller 240 can also confirm that, for example, the IDU 200 continues functioning as an access point with respect to the ODU 100 in the “slave device tethering mode”.

### Configuration Example of Slave Device

FIG. 3 is a diagram illustrating a configuration example of the slave device 300.

As illustrated in FIG. 3, the slave device 300 includes a WLAN communicator 310, a memory 320, and a controller 330.

The WLAN communicator 310 can wirelessly communicate with the IDU 200 using a wireless communication scheme conforming to Wi-Fi 6. That is, the WLAN communicator 310 converts (down-converts) a radio signal received from the IDU 200 into a baseband signal, and outputs the baseband signal to the controller 330. The WLAN communicator 310 converts (up-converts) a baseband signal received from the controller 240 into a radio signal, and transmits the radio signal to the IDU 200. Through such transmission and reception of radio signals, the slave device 300 can wirelessly communicate with the IDU 200 using Wi-Fi 6. The slave device 300 can access the cellular communication via the IDU 200 and the ODU 100 using the wireless communication with the IDU 200, and can receive the wireless service provided by the cellular communication.

The memory 320 stores a program and data. The program is read from the memory 320 and executed by the controller 330, so that various functions are executed by the controller 330. The memory 320 is used as a work region that temporarily stores a processing result of the controller 330. The memory 320 may be a freely selected non-transitory storage medium such as a semiconductor storage medium.

The controller 330 controls the units 310 and 320 of the slave device 300.

Note that the slave device 300 may be a third communication apparatus.

An operation example according to the first embodiment will be described. A Comparative Example to be compared with the operation example will be described first.

### COMPARATIVE EXAMPLE

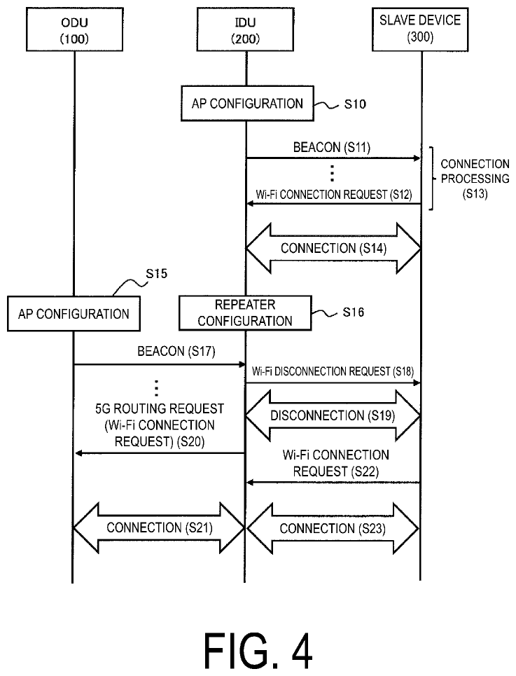

FIG. 4 is a diagram illustrating an operation example of the communication system 10 according to a Comparative Example.

As illustrated in FIG. 4, in Step S10, the IDU 200 performs access point (AP) configuration.

In Step S11, the IDU 200 broadcasts a beacon.

In Step S12, the slave device 300 that has received the beacon transmits a Wi-Fi connection request to the IDU 200. The slave device 300 performs a series of connection processing (Step S13) from the beacon reception to the Wi-Fi connection request. The connection processing includes processing and the like of transmitting and receiving a probe message and an authentication message.

Upon completion of the connection processing (Step S13), the IDU 200 and the slave device 300 establish a connection in Step S14.

In Step S15, the ODU 100 performs AP configuration. For example, the ODU 100 performs AP configuration when the ODU 100 is removed from the IDU 200. The ODU 100 may perform AP configuration when the ODU 100 is removed from the IDU 200 and is powered on by a user.

On the other hand, in Step S16, the IDU 200 performs repeater configuration. For example, the IDU 200 performs repeater configuration when receiving a beacon (Step S17) from the ODU 100. The IDU 200 may perform repeater configuration after transmitting a Wi-Fi connection request (or a wireless connection request) (Step S20) to the ODU 100. Repeater configuration is configuration of a relay function.

The repeater configuration changes the role of the IDU 200 from serving as an access point to performing a relay function (or serving as a slave device). Therefore, in Step S18, the IDU 200 transmits a Wi-Fi disconnection request to the slave device 300. In Step S19, the IDU 200 and the slave device 300 are disconnected from each other.

On the other hand, the IDU 200 performs connection processing from the beacon reception (Step S17) to the Wi-Fi connection request transmission (Step S20) according to the AP configuration by the ODU 100. In Step S21, the IDU 200 establishes a connection to the ODU 100. Note that the Wi-Fi connection request in Step S20 may be a 5G routing request made by the IDU 200 to the ODU 100.

In the IDU 200, the relay function is configured through repeater configuration (Step S16). In Step S22, the IDU 200 receives the Wi-Fi connection request transmitted from the slave device 300. In Step S23, the IDU 200 establishes a connection to the slave device 300, again in response to the Wi-Fi connection request.

The Comparative Example is as described above. Thus, in the Comparative Example, when the IDU 200 is switched from serving as an access point to serving as a repeater (Step S16), the connection to the slave device 300 is disconnected (Step S19). Due to such a disconnection, throughput may decrease in the communication system 10.

The present disclosure aims to appropriately maintain the connection to the slave device (or terminal) 300. Therefore, in the first embodiment, the first communication apparatus 100 executes the “slave device tethering mode”. The “slave device tethering mode” is a communication mode in which the first communication apparatus 100 is a slave device with respect to the second communication apparatus 200 being an access point. The “slave device tethering mode” is a communication mode in which the first communication apparatus 100 relays cellular communication and wireless LAN communication to provide a wireless service to the slave device 300 via the second communication apparatus 200.

When the first communication apparatus 100 is in the “slave device tethering mode”, the second communication apparatus 200 continues functioning as an access point. Therefore, the second communication apparatus 200 need not switch from being the access point to being the repeater as in the first embodiment. Accordingly, the second communication apparatus 200 can appropriately maintain the connection to the slave device 300 in the entire communication system 10, without disconnecting from the slave device 300 caused by the switching.

An operation example according to the first embodiment will be described.

### Operation Example

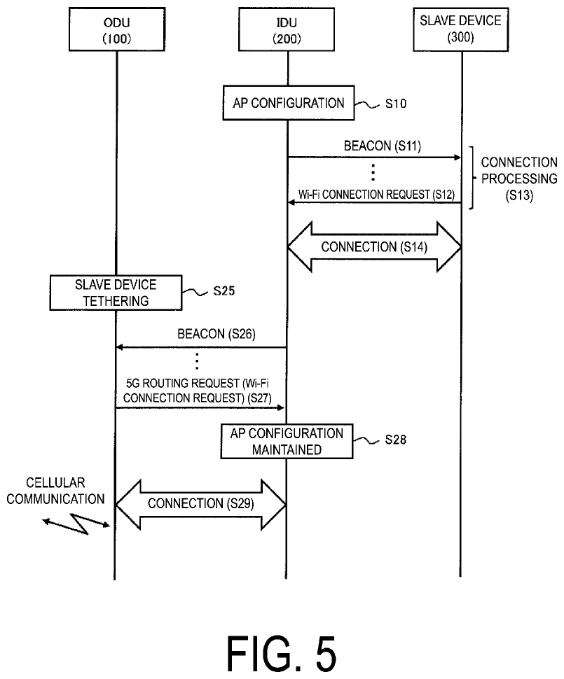

FIG. 5 is a diagram illustrating an operation example according to the first embodiment.

In FIG. 5, Steps S10 to S14 are respectively the same as Steps S10 to S14 in the Comparative Example (FIG. 4). That is, the IDU 200 periodically broadcasts a beacon message (Step S11) through the access point configuration (Step S10), and the slave device 300 having received the beacon message transmits a Wi-Fi connection request (Step S12), thereby completing connection between the IDU 200 and the slave device 300 (Step S14).

On the other hand, in Step S25, the ODU 100 executes a “slave device tethering mode” (or “slave device tethering”). For example, the ODU 100 may execute the “slave device tethering mode” when the ODU 100 is removed from the IDU 200 and is powered on. The ODU 100 may execute the “slave device tethering mode” when a user operates a predetermined button displayed on the display 130 of the ODU 100. The ODU 100 may execute the “slave device tethering mode” when receiving a beacon message from the IDU 200. The ODU 100, being an access point, does not transmit a beacon message.

In Step S26, the IDU 200 periodically broadcasts a beacon message.

The ODU 100 receives the beacon message and transmits a Wi-Fi connection request (or a wireless connection request) to the IDU 200 in Step S27. This Wi-Fi connection request is also a 5G routing request made by the ODU 100 to the IDU 200. The 5G routing request causes the ODU 100 to request the IDU 200 to function as a 5G router.

In step S28, the IDU 200 maintains the access point configuration. Therefore, the IDU 200 maintains the connection to the slave device 300 (step S14). Even when receiving a Wi-Fi connection request (or a wireless connection request) from the ODU 100, the IDU 200 also maintains the connection to the slave device 300 by maintaining the access point configuration.

Since the IDU 200 maintains the connection to the slave device 300, the IDU 200 need not receive the Wi-Fi connection request from the slave device 300 (Step S22 in FIG. 4). Therefore, in the first embodiment, user-friendliness can be improved due to being able to omit the operation of the Wi-Fi connection request by a user using the slave device 300.

In Step S29, the ODU 100 and the IDU 200 complete the series of connection processing (Step S26 and Step S27) and establish a connection.

### Second Embodiment

The first embodiment is described with reference to an example in which the ODU 100 executes the “slave device tethering mode”.

There is the following case, for example. The ODU 100 receives a beacon message from a certain access point. It may be unclear whether the ODU 100 is to be connected to the access point in the “slave device tethering mode” or is to be connected to the access point as a normal “slave device”.

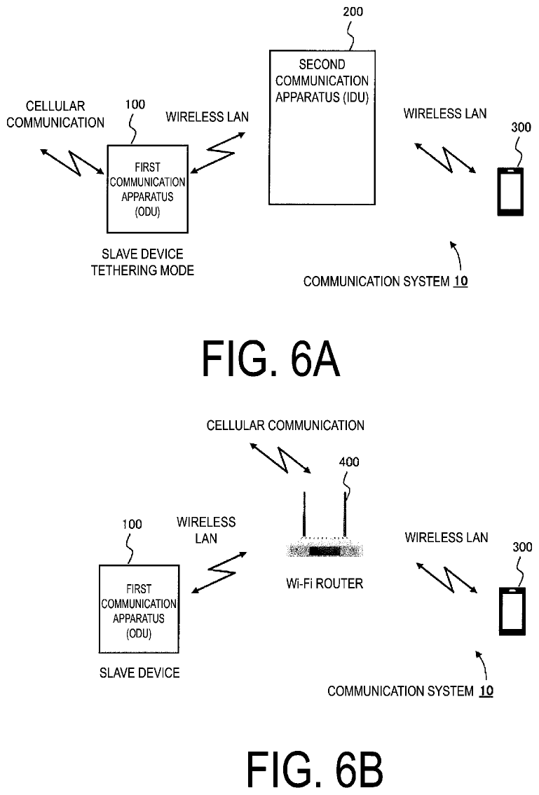

FIGS. 6A and 6B are diagrams illustrating connection examples. FIG. 6A illustrates an example in which the ODU 100 is connected to the IDU 200 (access point) in the “slave device tethering mode”. On the other hand, FIG. 6B illustrates an example in which the ODU 100 connects to the Wi-Fi router 400 as a normal “slave device”.

As illustrated in FIG. 6A, when the ODU 100 accesses the access point (IDU 200) in the “slave device tethering mode”, the ODU 100 itself relays the cellular communication. On the other hand, as illustrated in FIG. 6B, when the ODU 100 accesses the access point (Wi-Fi router 400) as a normal “slave device”, the Wi-Fi router 400 relays the cellular communication. In the case of FIG. 6B, the ODU 100 also functions as a slave device of the Wi-Fi router 400, similarly to the slave device 300.

As described above, when connecting to the access point in the “slave device tethering mode” and when connecting to the access point as the normal “slave device”, the ODU 100 and the IDU 200 have different functions. It is unclear when the ODU 100 is to function in the “slave device tethering mode” in some cases.

In the second embodiment, when receiving a beacon message including apparatus information indicating the IDU 200 is an access point, the ODU 100 executes the “slave device tethering mode”. On the other hand, when receiving a beacon message including apparatus information indicating an apparatus other than the IDU 200 is an access point, the ODU 100 executes the normal “slave device” mode. The ODU 100 may execute the “slave device” mode, when not receiving apparatus information indicating the IDU 200 is an access point.

As described above, depending on whether or not the apparatus information included in the beacon message is information indicating the IDU 200 is an access point, the ODU 100 can determine whether to connect to the access point in the “slave device tethering mode”.

Note that the apparatus information indicating the IDU 200 is an access point may be an identifier of the IDU 200. The apparatus information indicating the IDU is an access point may be a Service Set Identifier (SSID) issued by the IDU 200. With such apparatus information, the ODU 100 can recognize that the IDU 200 is an access point, and thus can determine that the “slave device tethering mode” is to be executed.

On the other hand, the apparatus information indicating an apparatus other than the IDU 200 is an access point may be an identifier of another access point (or router), for example, the Wi-Fi router 400, and/or an SSID issued by the Wi-Fi router 400. With such apparatus information, the ODU 100 can recognize that the access point is an apparatus other than the IDU 200, and thus can determine that the normal “slave device” mode is to be executed.

Note that when the “slave device tethering mode” is the first communication mode, the “slave device” mode is the second communication mode.

### Operation Example

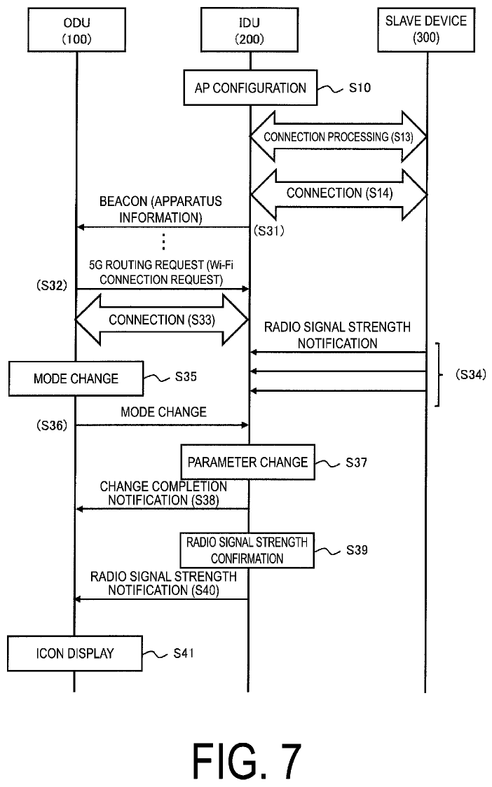

FIG. 7 is a diagram illustrating an operation example according to the second embodiment.

As shown in FIG. 7, the IDU 200 performs connection processing (Steps S10 and S13) with respect to the slave device 300 to establish a connection (Step S14), as in the first embodiment.

In Step S31, the IDU 200 periodically broadcasts a beacon message including apparatus information indicating the IDU 200 is an access point.

In this case, the IDU 200 may transmit the beacon message when a predetermined condition is satisfied. The predetermined condition may be that the IDU 200 is connected to at least one slave device 300. The predetermined condition may be that the IDU 200 is connected to a predetermined number or more of slave devices 300. The predetermined condition may be that the IDU 200 is configured by a user to be in a specific mode.

In Step S32, the ODU 100 transmits a Wi-Fi connection request (or a wireless connection request) to the IDU 200 based on apparatus information indicating the IDU 200 is an access point. This Wi-Fi connection request is also a 5G routing request made by the ODU 100, as in the first embodiment.

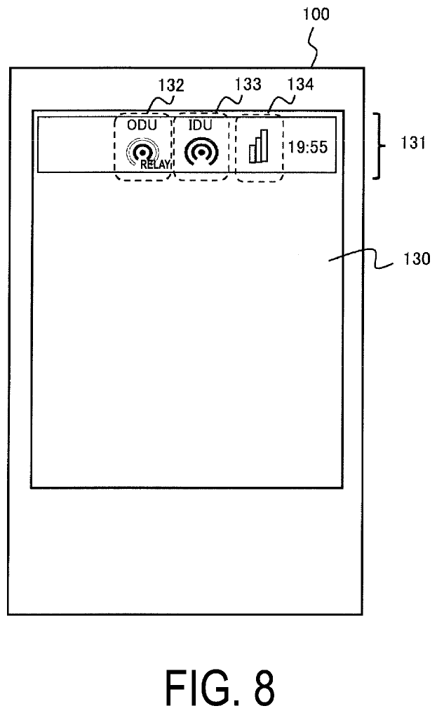

Note that when acquiring apparatus information indicating the IDU 200 is an access point, the ODU 100 may transmit a Wi-Fi connection request based on the apparatus information (in the “slave device tethering mode”). When acquiring apparatus information indicating an apparatus other than the IDU 200 is an access point from a router other than the IDU 200, the ODU 100 may transmit a Wi-Fi connection request based on the apparatus information (in the normal “slave device” mode). However, in the example illustrated in FIG. 8, the ODU 100 transmits a Wi-Fi connection request in the “slave device tethering mode”.

In Step S33, a connection is established between the ODU 100 and the IDU 200.

In Step S34, the IDU 200 receives a radio signal strength notification from the slave device 300. For example, the IDU 200 receives as many radio signal strength notifications as the number of connected slave devices 300. The slave device 300 may measure the radio signal strength with respect to the IDU 200 based on a radio signal (or message) received from the IDU 200. For example, the measurement is performed by the controller 330 of the slave device 300.

On the other hand, in Step S35, when establishing a wireless connection to the IDU 200, the ODU 100 changes the mode. The mode change is changing from the normal “slave device” mode to the “slave device tethering mode”. The ODU 100 is configured to be in the “slave device” mode as a default. The ODU 100 changes the mode to the “slave device tethering mode”, in response to receiving a beacon message including the apparatus information indicating the IDU 200 is an access point. Therefore, the beacon message triggers a mode change. The mode change is performed by the controller 160 of the ODU 100, for example. The mode change is performed, for example, due to the controller 160 configuring the “slave device tethering mode” (Step S25 in FIG. 5) described in the first embodiment.

Upon completion of the mode change processing, the ODU 100 transmits a mode change completion notification to the IDU 200 in Step S36.

In Step S37, the IDU 200 changes a parameter, in response to reception of the mode change completion notification. The IDU 200 performs, as a parameter change, processing of changing a default gateway from the IDU 200 to the ODU 100, for example.

In Step S38, upon completion of the parameter change, the IDU 200 transmits a change completion notification to the ODU 100.

In Step S39, the IDU 200 confirms the radio signal strength of the slave device 300 received in Step S34.

In Step S40, the IDU 200 transmits a radio signal strength notification to the ODU 100. The radio signal strength notification is, for example, a collection of radio signal strengths received by IDU 200 from the slave devices 300 in Step S34.

Note that the IDU 200 may transmit the information corresponding to the wireless connection to the IDU 200 to the ODU 100 by including the information in the radio signal strength notification or by using another message. Examples of the information corresponding to the wireless connection include the number of slave devices 300 connected to the IDU 200 or the maximum number of slave devices 300 connectable to the IDU 200. The IDU 200 can acquire the number of slave devices 300 connected to the IDU 200 at the time of connection processing to the slave device 300. The IDU 200 can transmit the acquired number of slave devices 300 to the ODU 100. The IDU 200 can read the maximum number of slave devices 300 connectable to the IDU 200 from the memory 220. The IDU 200 can transmit the read maximum number to the ODU 100.

In Step S41, the ODU 100 displays an icon based on the received radio signal strength notification. At this time, the ODU 100 may display the icon based on the information corresponding to the wireless connection and the radio signal strength notification.

FIG. 8 is a diagram illustrating a display example of icons displayed on the display 130 of the IDU 200. At the top of the display 130 is a picto region 131. The picto region 131 includes a display region 132 for the ODU 100, a display region 133 for the IDU 200, and a radio signal strength display region 134.

In the display region 132 for the ODU 100, a predetermined image representing a radio signal strength of communication between the ODU 100 and the IDU 200 is displayed.

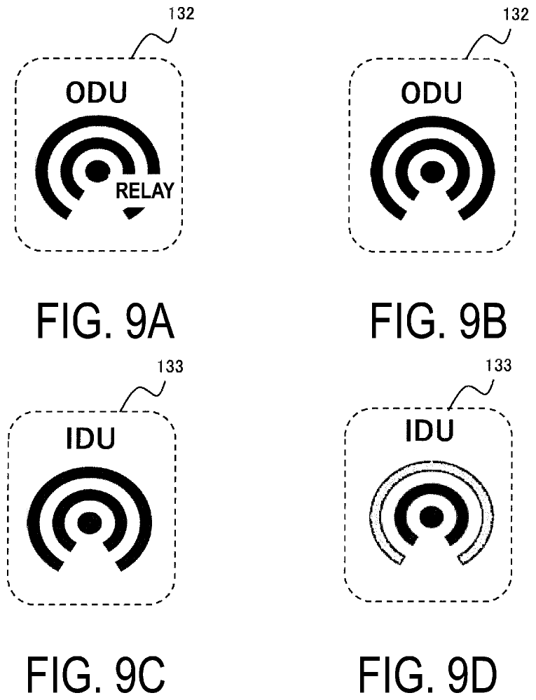

FIGS. 9A and 9B are diagrams illustrating examples of the first icon displayed in the display region 132 for the ODU 100 as the predetermined image.

FIG. 9A is a diagram illustrating an example of the first icon when the ODU 100 is connected to the IDU 200 in the “slave device tethering mode”. As shown in FIG. 9A, the icon includes the text for “Relay”.

On the other hand, FIG. 9B is a diagram illustrating an example of the first icon when the ODU 100 is connected to the IDU 200 in the normal “slave device” mode. As shown in FIG. 9B, the icon does not include the text for “Relay”. As described above, the display of the icon when the ODU 100 executing the “slave device tethering mode”, and the display of the icon when the ODU 100 is executing the “slave device” mode are different. The display may be different depending on each mode, and whether the text for “relay” are included is an example thereof.

As illustrated in FIG. 8, a predetermined image representing the radio signal strength of communication between the IDU 200 and the slave device 300 is displayed in the display region 133 for the IDU 200.

FIGS. 9C and 9D are diagrams illustrating examples of the second icon displayed as the predetermined image in the display region for the IDU 200.

As shown in FIG. 9C, similarly to FIG. 9B, the second icon is displayed as a display for the normal “slave device” mode (display without the text, “Relay”).

As shown in FIG. 9D, the magnitude of the radio signal strength is represented through a circle display method. For example, when the radio signal strength is the strongest, all the circles are displayed in “black” as illustrated in FIGS. 9A to 9C. As the radio signal strength decreases, the display changes from “black” to “gray” in the order from the outside of the icon.

When a plurality of slave devices 300 are connected to the IDU 200, for example, the following display is performed. As the second icon displayed in the display region 133 for the IDU 200, a representative value of radio signal strengths of the plurality of slave devices 300 may be displayed. The representative value may be an average value, a weakest value, or a maximum value of the radio signal strengths of the plurality of (connected) slave devices 300. The display region 133 may display all of the radio signal strengths of the plurality of slave devices 300 side by side. The display region 133 may also display all of the radio signal strengths of the plurality of slave devices 300 at predetermined time intervals. A representative icon may be displayed in the display region 133. In this case, when an operation (an operation via a touch panel, an operation via a physical key, a voice instruction using a microphone, or the like) with respect to the displayed icon is received, each radio signal strength of the plurality of slave devices 300 may be displayed. In this case, as the “representative icon”, an icon indicating an average value (or a statistically calculated representative value) of the radio signal strengths may be displayed. The display mode of the second icon may be changed according to the number of terminals connected to the IDU 200. For example, when the number of slave devices 300 connected to IDU 200 is one, the icon shown in FIG. 9C or 9D may be displayed, and when the number of slave devices 300 connected to IDU 200 is two or more, an icon (an icon indicating an average value of the radio signal strengths) shown in FIG. 9C to which characters “+2” are added may be displayed. When a predetermined operation is received in a state in which the icon to which the characters “+2” are added is displayed, the radio signal strength of each of the plurality of slave devices 300 (the plurality of connected slave devices 300) may be displayed. In this case, the icon displayed when the number of apparatuses connected to the IDU 200 is one may be configured so as not to receive a predetermined operation.

As shown in FIG. 8, the first icon and the second icon may be displayed at positions adjacent to each other or in the vicinity of each other. At least the number of slave devices 300 connected to the IDU 200 may be displayed along with the second icon. The maximum number of slave devices 300 connectable to the IDU 200 may be displayed along with the second icon.

As shown in FIG. 8, a third icon is displayed as a predetermined image in the radio signal strength display region 134. The third icon represents a radio signal strength for cellular communication (5G) in the ODU 100. In the example illustrated in FIG. 8, in the third icon, the magnitude of the radio signal strength is represented by a plurality of bars having different heights. When the radio signal strength is the strongest, all the bars are displayed, and as the radio signal strength decreases, the bars are no longer displayed in the order from the highest bar.

The predetermined image as described above is displayed, for example, through control of the display 130 by the controller 160 of the ODU 100 based on the radio signal strength notification (Step S40 in FIG. 7) received from the slave device 300 via the IDU 200.

As used in the present disclosure, the phrase “based on” or “in response to” does not mean “based only on” or “only in response to” unless expressly specified otherwise. The phrase “based on” means both “based only on” and “based at least in part on”. Similarly, the phrase “in response to” means both “only in response to” and “at least partially in response to”. “Obtain” or “acquire” may mean to obtain information from among stored information. “Obtain” or “acquire” may also mean to obtain information from among information received from other nodes. “Obtain” or “acquire” may also mean obtaining information by generating the information. The terms “include”, “comprise”, and variations thereof do not mean the inclusion of only the listed items, but may also mean the inclusion of only the listed items or the inclusion of additional items in addition to the listed items. The term “or” used in the present disclosure is not intended to be an exclusive OR. Any reference to elements using a designation such as “first”, “second”, and the like as used in the present disclosure does not generally limit the quantity or order of those elements. These designations may be used in the present specification as a convenient method of distinguishing between two or more elements. Thus, a reference to first and second elements does not mean that only two elements may be employed there or that the first element must precede the second element in some manner. In the present disclosure, when articles are added by translation, for example, “a”, “an”, and “the” in English, these articles are intended to include the plural unless the context clearly indicates otherwise.

### Other Embodiments

Embodiments have been described above in detail with reference to the drawings, but specific configurations are not limited to those described above, and various design variation can be made without departing from the gist of the present disclosure. The above-described embodiments can be appropriately combined as long as no inconsistencies are introduced.

### REFERENCE SIGNS

10: Communication system
100: First communication apparatus (ODU)
110: Cellular communicator
120: WLAN communicator
130: Display
132: Display region
133: Display region
134: Radio signal strength display region
140: Memory
150: Charger
160: Controller
200: Second communication apparatus (IDU)
210: WLAN communicator
220: Memory
230: Power feeder
240: Controller
300 (300-1, 300-2): Slave device
310: WLAN communicator
320: Memory
330: Controller

The invention claimed is:

1. A communication apparatus comprising:
a first communicator configured to wirelessly communicate using a cellular communication scheme;
a second communicator configured to wirelessly communicate with another communication apparatus using a first communication scheme different from the cellular communication scheme; and
a controller configured to control the first communicator and the second communicator, and to execute a first communication mode, wherein
the second communicator is configured to transmit a wireless connection request to the other communication apparatus in the first communication mode, and
the first communication mode is a communication mode in which the communication apparatus is a slave device with respect to the other communication apparatus being an access point, communication through the cellular communication scheme and communication through the first communication scheme are relayed, and a wireless service is provided, via the other communication apparatus, to a terminal apparatus configured to wirelessly communicate with the other communication apparatus through the first communication scheme.

2. The communication apparatus according to claim 1, wherein the controller is configured to execute the first communication mode in response to the second communicator receiving first apparatus information regarding the other communication apparatus from the other communication apparatus.

3. The communication apparatus according to claim 2, wherein the controller is configured to execute a second communication mode in which the controller controls the second communicator to cause the communication apparatus to become a slave device with respect to the other communication apparatus being an access point, in response to the second communicator receiving, from a communication apparatus other than the other communication apparatus, second apparatus information regarding the communication apparatus.

4. The communication apparatus according to claim 3, wherein the controller executes the second communication mode when the second communicator does not receive the first apparatus information.

5. The communication apparatus according to claim 1 further comprising:
a display, wherein
the display is configured to display a predetermined image when the controller executes the first communication mode.

6. The communication apparatus according to claim 5, wherein the display displays, as the predetermined image, at least a first icon indicating a radio signal strength of communication between the other communication apparatus and the terminal apparatus.

7. The communication apparatus according to claim 5, wherein the display displays, as the predetermined image, a second icon indicating a radio signal strength of communication between the communication apparatus and the other communication apparatus.

8. The communication apparatus according to claim 7, wherein when the terminal apparatus comprises a plurality of terminal apparatuses, the display displays, as the second icon, an average value or a representative value of each radio signal strength of communication between each of the plurality of terminal apparatuses and the other communication apparatus.

9. The communication apparatus according to claim 5, wherein the display displays the first icon and the second icon at positions adjacent to each other.

10. The communication apparatus according to claim 5, wherein the display displays, as the predetermined image, at least the number of terminal apparatuses connected to the other communication apparatus.

11. The communication apparatus according to claim 5, wherein the display displays, along with the predetermined image, the maximum number of terminal apparatuses connectable to the other communication apparatus.

12. The communication apparatus according to claim 1, wherein the first communication scheme is a wireless Local Area Network (LAN) communication scheme or a short-range wireless communication scheme.

13. A communication apparatus comprising:
a communicator configured to wirelessly communicate with another communication apparatus and a terminal apparatus using a first communication scheme different from a cellular communication scheme; and
a controller, wherein
the communicator receives a wireless connection request from the other communication apparatus in a first communication mode,
the controller maintains a connection to the terminal apparatus even when the communicator receives the wireless connection request, and
the first communication mode is a communication mode in which the other communication apparatus is a slave device with respect to the communication apparatus being an access point, communication through the cellular communication scheme and communication through the first communication scheme are relayed by the other communication apparatus, and a wireless service is provided to the terminal apparatus.

14. The communication apparatus according to claim 13, wherein the communicator transmits apparatus information on the communication apparatus to the other communication apparatus.

15. The communication apparatus according to claim 14, wherein
the communicator transmits the apparatus information to the other communication apparatus when a predetermined condition is satisfied, and
the predetermined condition is that the communication apparatus is connected to at least one of the terminal apparatuses, that the communication apparatus is connected to a predetermined number or more of the terminal apparatuses, or that the communication apparatus is designated by a user to be in a specific mode.

16. The communication apparatus according to claim 13, wherein the communicator transmits, to the other communication apparatus, information corresponding to a wireless connection to the communication apparatus.

17. The communication apparatus according to claim 16, wherein the information corresponding to the wireless connection is the number of the terminal apparatuses connected to the communication apparatus, or the maximum number of the terminal apparatuses connectable to the communication apparatus.

18. A communication system comprising:
a first communication apparatus configured to wirelessly communicate using a cellular communication scheme and to wirelessly communicate using a first communication scheme different from the cellular communication scheme;
a second communication apparatus configured to wirelessly communicate with the first communication apparatus using the first communication scheme; and
a terminal apparatus configured to wirelessly communicate with the second communication apparatus using the first communication scheme, wherein
the first communication apparatus transmits a wireless connection request to the second communication apparatus in a first communication mode,
the second communication apparatus maintains a connection to the terminal apparatus even when receiving the wireless connection request, and
the first communication mode is a communication mode in which the first communication apparatus is a slave device with respect to the second communication apparatus being an access point, communication through the cellular communication scheme and communication through the first communication scheme are relayed by the first communication apparatus, and a wireless service is provided to the terminal apparatus via the second communication apparatus.
